(19) United States
(12) Patent Application Publication
(10) Pub. No.: US 2023/0396586 A1
(43) Pub. Date: Dec. 7, 2023

(54) INTELLIGENT FIREWALL USING IDENTIFICATION OF VALID TRAFFIC

(71) Applicant: CenturyLink Intellectual Property LLC, Broomfield, CO (US)

(72) Inventors: John R.B. Woodworth, Amissville, VA (US); Dean Ballew, Sterling, VA (US)

(73) Assignee: CenturyLink Intellectual Property LLC, Broomfield, CO (US)

(21) Appl. No.: 18/329,337

(22) Filed: Jun. 5, 2023

Related U.S. Application Data
(60) Provisional application No. 63/365,978, filed on Jun. 7, 2022.

(51) Int. Cl. H04L 9/40

(52) U.S. Cl. CPC H04L 63/0245; H04L 63/0236

(57) ABSTRACT

In a network in which connections are made, between devices or between network segments, through security devices such as firewalls, a user attempting to contact a destination device may be prevented from doing so by some or all of the security devices, which may silently block packets, sent by the user, addressed to the destination device. The remedying of this inability to contact the destination device may be made more difficult by a lack of knowledge, on the part of the user, regarding which security devices are configured to block the packets. As such, a system and method for managing network access are provided.

### CROSS-REFERENCE TO RELATED APPLICATIONS

This application claims the benefit of U.S. Provisional Application No. 63/365,978 filed Jun. 7, 2022, entitled “Intelligent Firewall Using Identification of Valid Traffic,” which is incorporated herein by reference in its entirety.

### FIELD

One or more aspects of embodiments according to the present disclosure relate to network access, and more particularly to a system and method for managing network access.

### BACKGROUND

In a network in which connections are made, between devices or between network segments, through security devices such as firewalls, a user attempting to contact a destination device may be prevented from doing so by some or all of the security devices, which may silently block packets, sent by the user, addressed to the destination device. The remedying of the inability to contact the destination device may be made more difficult by a lack of knowledge, on the part of the user, regarding which security devices are configured to block the packets.

It is with respect to this general technical environment that aspects of the present disclosure are related.

### SUMMARY

Systems and methods for managing network access are provided. In an aspect, a method includes receiving, by a security device, a packet including a ticket identifier, and determining, by the security device, a disposition of the packet. The method may further include logging, by the security device, the disposition of the packet, with the ticket identifier, and with an identifier of the security device.

In another aspect, a method, includes: receiving a request for a first ticket identifier from a source device; providing the first ticket identifier to the source device; receiving log information from a first security device indicating the first ticket identifier was received by the first security device; verifying access for the source device; and automatically reconfiguring the first security device to permit packets from the source device to be passed through the first security device.

In another aspect, a security device is provided, comprising: at least one processing circuit; and memory, operatively connected to the at least one processing circuit and storing instructions that, when executed by the at least one processing circuit, causes the security device to perform a method. In aspects, the method comprises: receiving a packet including a ticket identifier; determining a disposition of the packet; and logging the disposition of the packet, with the ticket identifier, and an identifier of the security device.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

These and other features and advantages of the present disclosure will be appreciated and understood with reference to the specification, claims, and appended drawings. Non-limiting and non-exhaustive examples are described with reference to the following Figures.

FIG. 1 is a block diagram of a network, according to an example of the present disclosure;

FIG. 2A is a flow chart of a method, according to an example of the present disclosure;

FIG. 2B is a flow chart of a method, according to an example of the present disclosure;

FIG. 2C is a flow chart of a method, according to an example of the present disclosure;

FIG. 2D is a flow chart of a method, according to an example of the present disclosure;

FIG. 2E is a flow chart of a method, according to an example of the present disclosure;

FIG. 3A is a flow chart of a method, according to an example of the present disclosure;

FIG. 3B is a flow chart of a method, according to an example of the present disclosure;

FIG. 3C is a flow chart of a method, according to an example of the present disclosure;

FIG. 3D is a flow chart of a method, according to an example of the present disclosure;

FIG. 3E is a flow chart of a method, according to an example of the present disclosure;

FIG. 4 is a block diagram of an operating environment, according to an example of the present disclosure.

### DETAILED DESCRIPTION

The detailed description set forth below in connection with the appended drawings is intended as a description of exemplary embodiments of a system and method for managing network access provided in accordance with the present disclosure and is not intended to represent the only forms in which the present disclosure may be constructed or utilized.

In the following detailed description, references are made to the accompanying drawings that form a part hereof, and in which are shown by way of illustrations specific embodiments or examples. These aspects may be combined, other aspects may be utilized, and structural changes may be made without departing from the present disclosure. Examples may be practiced as methods, systems or devices. Accordingly, examples may take the form of a hardware implementation, an entirely software implementation, or an implementation combining software and hardware aspects. In addition, all systems described with respect to the Figures can comprise one or more machines or devices that are operatively connected to cooperate in order to provide the described system functionality. The following detailed description is therefore not to be taken in a limiting sense, and the scope of the present disclosure is defined by the appended claims and their equivalents.

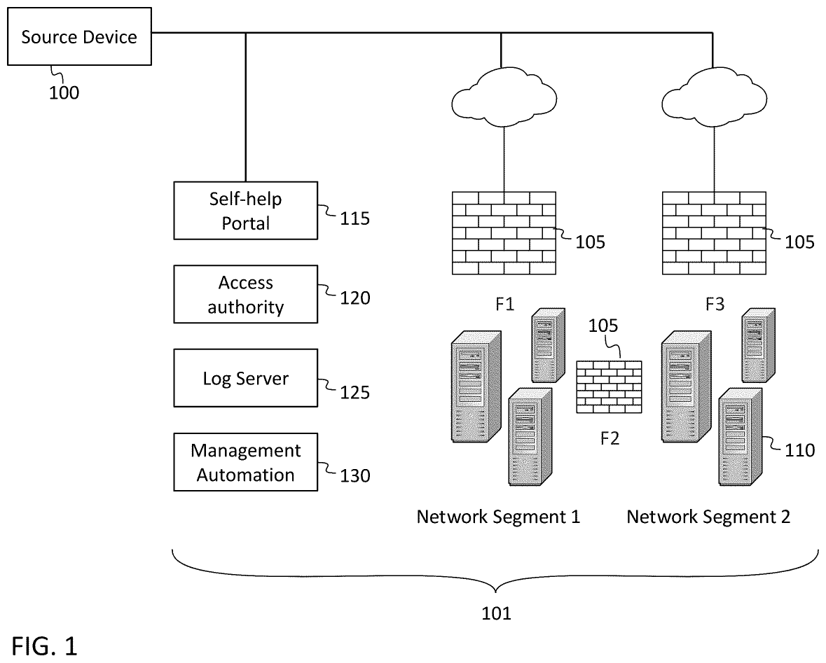

Referring to FIG. 1, when a user interacts, e.g., via a source device 100, with a network including security devices 105 such as firewalls F1, F2, F3, (or switches or routers or other devices that have packet-filtering capability), the user may on occasion be blocked from accessing a device 110 (which may be referred to as a “destination device”) on a particular network segment (e.g., a server on Network Segment 2) by one or more security devices that are between the source device 100 and the destination device 110. Even if the user is qualified to access the network segment (e.g., if the user is a trusted employee of an entity that owns and operates the network), the security devices may, by default, be configured not to grant access to each such user. As such, it may be necessary for the security devices to be reconfigured to enable access, by the user, to the destination device 110.

In some circumstances, this reconfiguring may be inefficient and time consuming, in part because the user may not know through which security device or security devices the path from the source device 100 to the destination device 110, once established, will pass, and because the user also may not know which security device or security devices require reconfiguring. As such, the user may, for example, contact a number of persons each responsible for a different security device in the system, and arrange to be granted access to transmit packets through the security device. If a large number of security devices are involved or if the procedure for requesting and being granted access is involved, this process may be time consuming. Moreover, a significant portion of the effort may be wasted, if some of the some of the security devices are already configured, without the user being aware of it, to forward packets the user may send to the destination device 110.

In some examples, therefore, a network system 101, as illustrated in FIG. 1, may include, in addition to the network segments and security devices, additional components that may facilitate diagnosing and remedying the failure, by a user, to access a destination device 110. As used herein, a “network system” is a system including a network and such additional components. The additional components may include, as illustrated in FIG. 1, a self-help portal 115, an access authority 120, a log server 125, and management automation 130. Each of the access authority 120, the log server 125, and the management automation 130 may be, or may be implemented on or in, a server, or an operating environment (discussed in further detail below).

In such a system, the user may arrange for the source device 100 to transmit a packet to the destination device 110. The packet (which may be, e.g., a Transmission Control Protocol (TCP) packet or a User Datagram Protocol (UDP) packet) may be addressed to a port (or “destination port”) of the destination device 110 and to a destination IP address which is the IP address of the destination device 110, and the packet may include a number that may be referred to herein as a “ticket identifier” which is associated with the user and with the source device 100. The ticket identifier may be a trusted, e.g., encrypted attribute within the packet, so the target can trust the client, and vice versa. For example, the ticket identifier may be a moderate-length number (e.g., a 20-character (160-bit) number) that is unlikely to be in simultaneous use by another user of network system 101. For example, it may be, or include, (i) the source Internet Protocol (IP) address (e.g., the IP address of the source device 100 or the IP address to which the IP address of the source device 100 is translated by Network Address Translation (NAT)), (ii) a number selected by the user (who may, for example, select the user's telephone number), (iii) a number generated by the network system 101 (e.g., by the self-help portal 115 or by the access authority 120). In the case of a ticket identifier that is not supplied by the user but generated by the network system 101 (e.g., by the self-help portal 115 or by the access authority 120), the ticket identifier may be selected to be unique (e.g., among recently generated ticket identifiers, or among all ticket identifiers ever generated by the network system 101). The ticket identifier may be or include a password, or a digital signature. As used herein, a “password” is a shared secret, such as a number (which may be represented to the user as a string of numbers or letters) that is not publicly accessible and that gives a person in possession of it certain privileges in the network system 101. In some examples a password is a number that is created by the user of source device 100 or divulged only to the user for whom it is generated.

If the ticket identifier includes a password, it may be obtained, or specified, by the user using an authentication process (e.g., a two-factor authentication process). For example, the user may access the self-help portal 115 (e.g., through the source device 100) and submit (using a suitable user interface, e.g., via a browser) a request to access the destination device 110. The self-help portal 115 may provide an opportunity for the user to explain a business case or other reason for needing access to the destination device 110, and the issuing of the ticket identifier may be contingent on one or more of: (i) the user having provided such an explanation or (ii) the explanation also having been deemed acceptable (e.g., by a network administrator or supervisor). The network system 101 may then generate the password (which may be, e.g., a pseudorandom number, or a cryptographic hash of a number that is difficult to predict in advance, such as a fine-grained time of day) and provide it to the source device for display or use, e.g., via the self-help portal 115, or otherwise provide it to the source device 100 or a user of the source device 100. In some examples, the user may instead specify the password (e.g., through a user interface enabled by the self-help portal 115, which password the network system 101 may check for uniqueness and strength before accepting it). In some examples, the network system 101 may automatically notify another user (e.g., a supervisor) whenever a ticket identifier is requested or issued, or it may wait for authorization from another user before issuing a ticket identifier. In some examples, the source device may include an application, plug-in, or other code to automatically insert the ticket identifier into packets sent to the destination device 110. In examples, the ticket identifier need not be displayed to a user of the source device 100, but may be stored at source device 100 and automatically inserted into (e.g., a header of) any packet directed to destination device 110. In examples, the insertion is not automatic, but the user may choose to use the identifier-inserting application (e.g., running on the source device 100), which inserts the ticket identifier into each packet sent to the destination device 110, during subsequent attempts to contact the destination device 110. In examples, the ticket identifier may also have a time-to-live (TTL) value associated with it, and the ticket identifier may only be valid for use in accessing the destination device 110 prior to the TTL expiring.

The ticket identifier may be used both for path testing and for obtaining access, each of which is discussed in further detail below. When performing path testing, the user may send a packet addressed to the destination device 110 primarily for the purpose of identifying security devices 105 that are blocking access to the destination device 110. The security devices may be configured to support path testing in several different ways. In some examples, a ticket identifier that may be referred to as a “testing ticket identifier” is used, e.g., by the identifier-inserting application, for path testing. A testing ticket identifier may be reusable, and it may not be necessary for the testing ticket identifier to be approved (e.g., by a network administrator). In some examples, each security device treats a packet containing a ticket identifier (which may be referred to as a “ticket-containing packet”) in the same manner as it would another packet (e.g., it may forward the packet if doing so is authorized by the forwarding rules with which it is programmed, and otherwise it may drop the packet), except that it may log the disposition of the packet, with the ticket identifier and with an identifier of the security device. The logging may include submitting to the log server 125 a report including (i) the ticket identifier, (ii) the identifier of the security device (which may be the IP address of the security device 105, submitted in the Source IP Address field of the header of a packet of the report), and (iii) the disposition of the packet, e.g., whether it was dropped or forwarded. In such a system, the user may, after sending a packet, submit (e.g., through the self-help portal 115) a query to the log server 125 (e.g., for all reports matching the ticket identifier) and identify, from the report, the first security device on the path that is configured to block packets sent from the source device 100 to the destination device 110. The user may then arrange for this first security device 105 to be reconfigured to forward packets that are sent by the source device 100 and addressed to the destination device 110, and repeat the process as often as needed to identify, and reconfigure, each of the security devices 105 on the path to the destination device 110, that are configured to block such packets. In such an example, it may be sufficient for the ticket identifier to be a user-generated string (e.g., the user's name or telephone number) and it may not be necessary that the ticket identifier have the characteristics of a password.

In some examples, each security device 105 is configured (a) to remove, from the packet, (i) the payload, or, if part of the payload is a portion of the ticket identifier, (ii) the remainder of the payload, (b) to forward the packet, and (c) to log whether forwarding of packets from the source device 100 to the destination device 110 is authorized for non-ticket-containing packets (e.g., to log what the disposition of the packet would have been had the packet not included a ticket identifier). In such an example, the packet may be transmitted to the destination device 110, and the user may subsequently obtain, by submitting a single suitable query to the log server 125 (and without having to repeatedly send packets and reconfigure security devices 105), a list of the security devices 105 that will need to be reconfigured to grant the user access to the destination device 110. The query may be submitted, e.g., using the self-help portal 115.

It may be that the path from the source device 100 to the destination device 110 changes with time (e.g., as loads on the connections within the network change, or as a result of connections being broken or otherwise becoming unavailable). As such, path testing may involve sending a plurality of packets (e.g., between 10 and 100 packets) from the source device 100 to the destination device 110, and generating a list of all of the security devices 105, that are (i) configured to block non-ticket-containing packets, sent from the source device 100 to the destination device 110, and that are (ii) on any such path (or on any path that is used more than a threshold fraction of the time (e.g. more than 5% of the time)). It may be that the discovery process using path testing fails to identify some such security devices 105. For example, a security device 105 may be on a disfavored path and therefore not discovered by path testing; the disfavored path may then become a favored path when a connection on another, previously favored path is broken. In such a case, path testing may be performed again (or periodically) as needed.

In some examples, as mentioned above, the ticket identifier may be used to obtain access to the destination device 110 (instead of, or in addition to, determining which security devices 105 need to be reconfigured for the user to obtain such access). This may be accomplished in various ways.

In some examples, the ticket identifier is or includes a password that grants the user access (e.g., temporary access) to the destination device 110. For example, when the ticket identifier is set (e.g., issued to the user), it may be stored, in the access authority 120, along with the requested destination IP address (the IP address of the destination device 110) and port number. The IP address of the source device 100 may or may not also be stored, with the ticket identifier, in the access authority 120. This information (the ticket identifier, the requested destination IP address and port number, and, optionally, the IP address of the source device 100) may also, or instead, be sent (e.g., by the access authority 120) to (i) all of the security devices in the network or (ii) the security devices on the path (or paths) from the source device 100 to the destination device 110.

A security device 105 may, if the information was not sent to it, periodically query the access authority 120 to determine whether forwarding of the packet is authorized. The query sent to the access authority 120 may include the ticket identifier, the destination port number, and the destination IP address, and, optionally, the source IP address (the IP address of the source device 100). When it is in possession of information indicating that forwarding of packets containing the ticket identifier is authorized, the security device 105 may forward any such packet. In some examples, the security device 105 may also change its configuration to forward packets from the source device 100 to the destination device 110, regardless of whether such packets contain the ticket identifier (such a change may be permanent or it may be reversed after the expiration of a TTL associated with the ticket identifier). In some examples, the changing of the configuration is contingent on, e.g., independent, corroborating confirmation (e.g., by a network administrator) that the configuration change is authorized. In some examples, the ticket identifier is or contains a digital signature (e.g., a cryptographic digital signature based on a public key algorithm). In such an example the security device 105 may be in possession of a public key for verifying such digital signatures and may be able to determine whether to forward the packet, and whether to change its configuration, based on determining whether the digital signature is authentic.

The ticket identifier may be stored in a packet in several ways. In some examples, the ticket identifier is stored in the packet header, e.g., in any header field compatible with such use (e.g., in the IP Options field of an IP packet). If the ticket identifier is the source IP address, then it may be stored in the Source IP Address field of the header (in this situation it may also be stored, e.g., in the IP Options field, or a flag may be set (e.g., in the IP Options field) to notify the security devices 105 that the packet is a ticket-containing packet). In some examples the ticket identifier, or a portion of the ticket identifier, may be stored in the payload of the packet. This may be advantageous if the ticket identifier is or contains a signature, which may be too large to fit readily into the packet header.

In some examples, once a list of the security devices 105 that will need to be reconfigured to grant the user access to the destination device 110 has been generated, the configuration of each security device 105 may be modified, to grant the user access to the destination device 110, without, or with little, further involvement by the user. For example, each security device 105 may modify its own configuration automatically, as discussed above, or the network system 101 may initiate a process (which may be triggered by the receipt, by any of the security devices 105, of a ticket-containing packet) to modify the configurations of the security devices 105 (e.g., of the security devices 105 identified in the discovery (e.g., path testing) process as being on potential paths), e.g., after confirming that access should be granted. In some examples, the network system 101 may automatically contact the user or another user, such as a network administrator, (e.g., via Short Message Service (SMS) or email) to request confirmation that modifications to security device configurations should be made. The security devices 105 may then be reconfigured automatically by the network system 101, or the network system 101 may send an automated request to a network administrator to modify the security device configurations. Such involvement of a network administrator may operate as an additional safety measure to the extent that a network administrator may be better able to identify suspicious requests. In some examples, a network administrator may periodically check the logs of the log server 125 and modify security devices 105 to grant access as appropriate.

In some examples, each ticket identifier may expire (e.g., cease to be treated as a ticket identifier by the security devices 105) after a TTL has elapsed (or “expired”) or after some event has occurred. For example, for path testing, the security devices 105 may be configured to forward only one packet based on any ticket identifier, so that if a second packet is sent with the same ticket identifier, it may be blocked. As another example, each of the security devices 105 may be informed (e.g., by the log server 125) of the time at which a ticket identifier was issued and its TTL. In other examples, each security device may be programmed to assume a TTL of a set period of time (e.g., 10 minutes or one hour) after that security device 105 receives notification of the ticket identifier. The security device 105 may reject (e.g., decline to treat as a ticket identifier) any ticket identifier the age of which exceeds the TTL communicated with the ticket identifier and/or an assumed TTL. In such examples, the TTL may be selected to be sufficient (i) to complete path testing, or (ii) to allow a user to complete a short-duration task requiring access to the destination device 110. In some examples, the user specifies the TTL at the time of submitting the ticket identifier request.

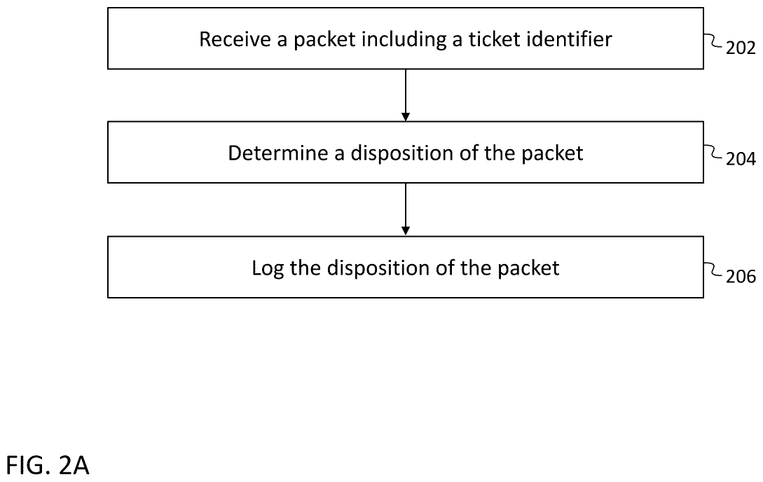

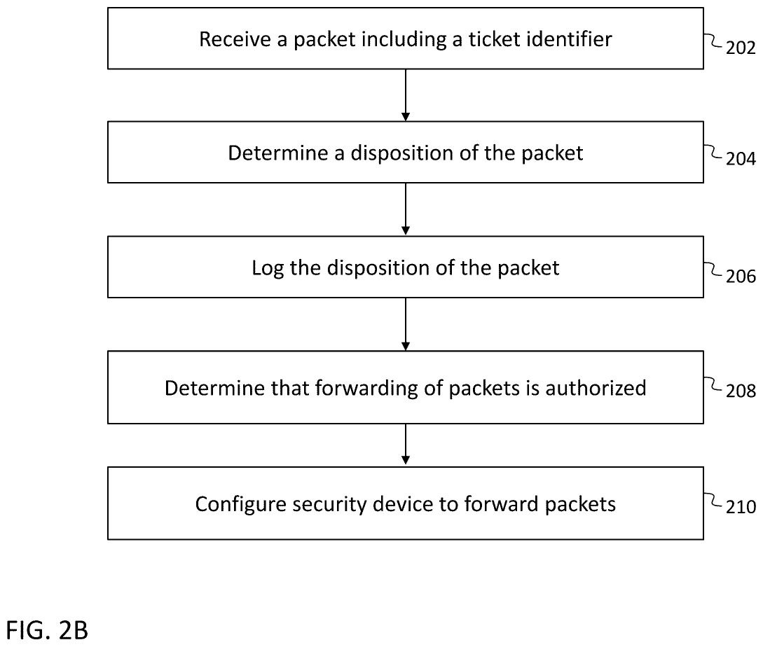

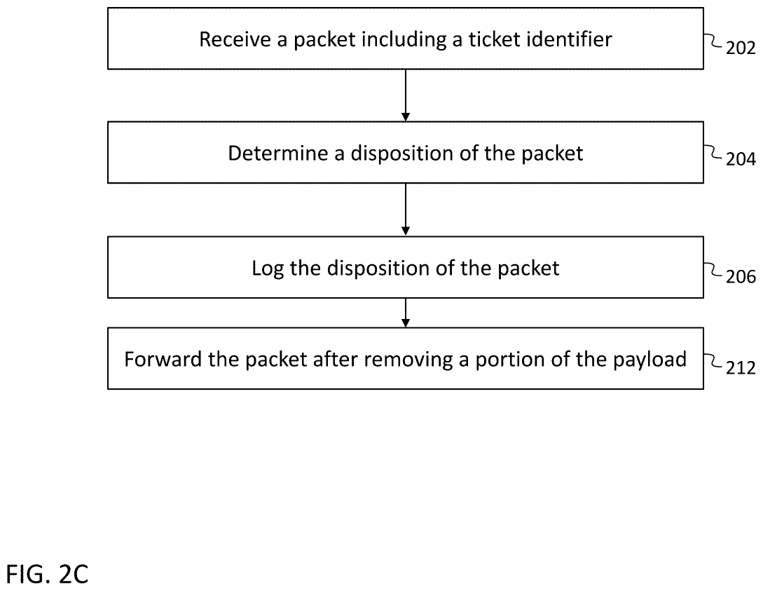

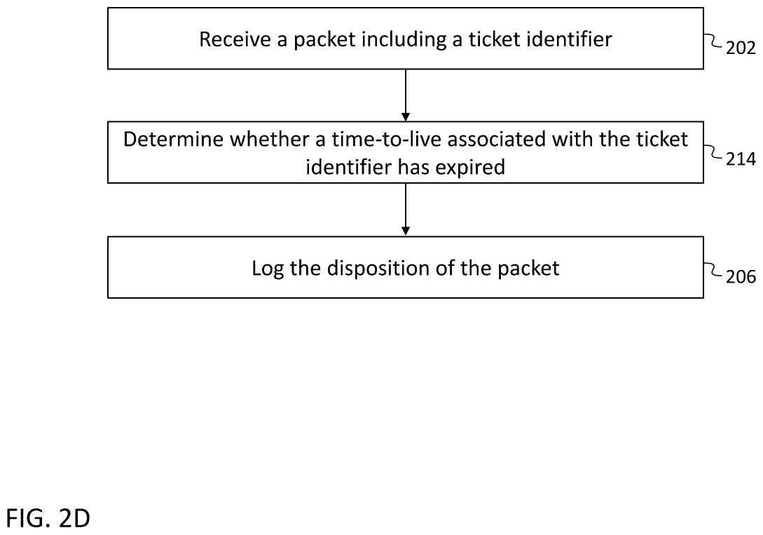

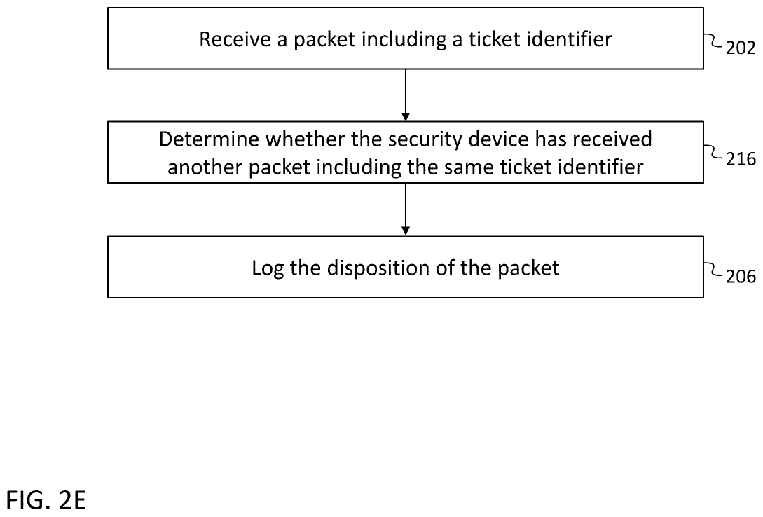

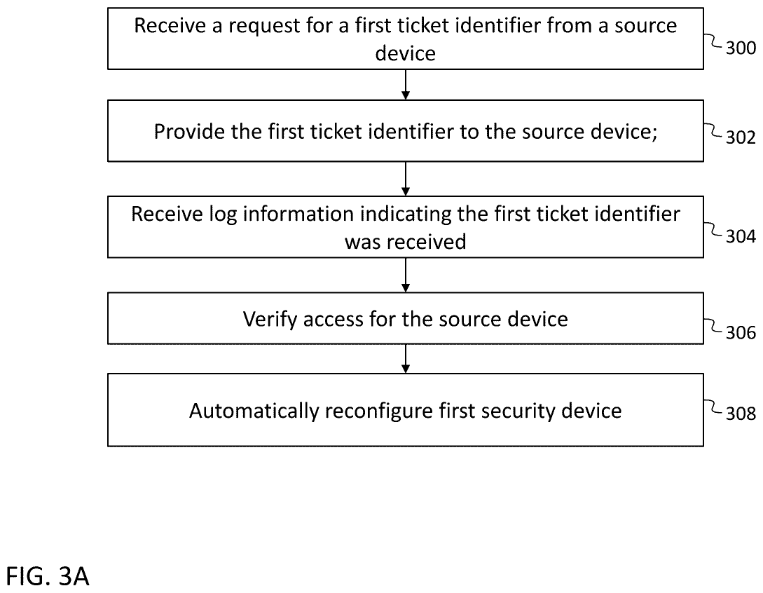

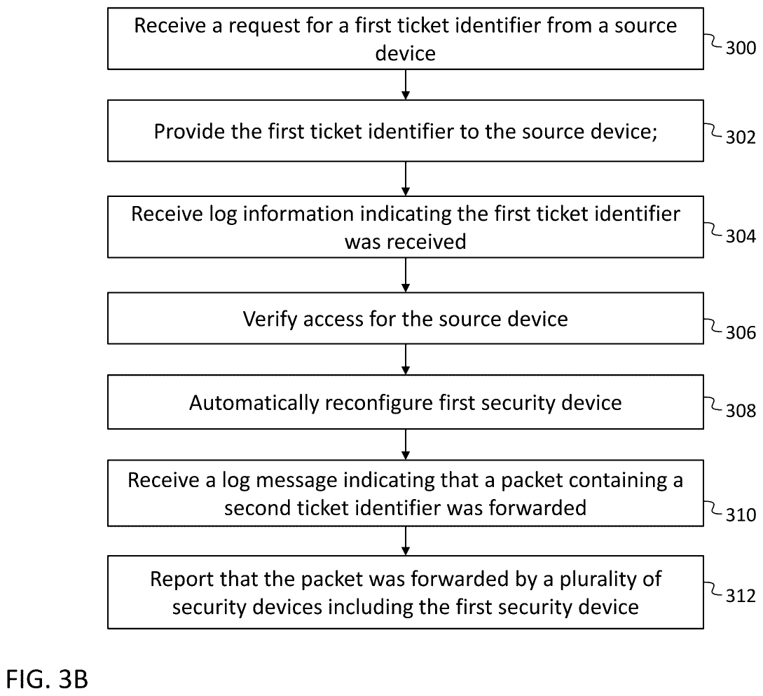

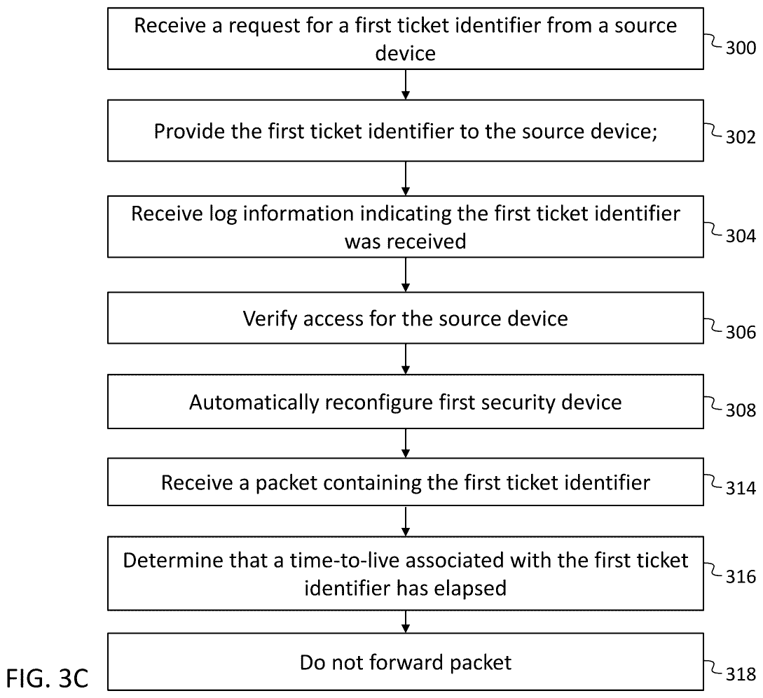

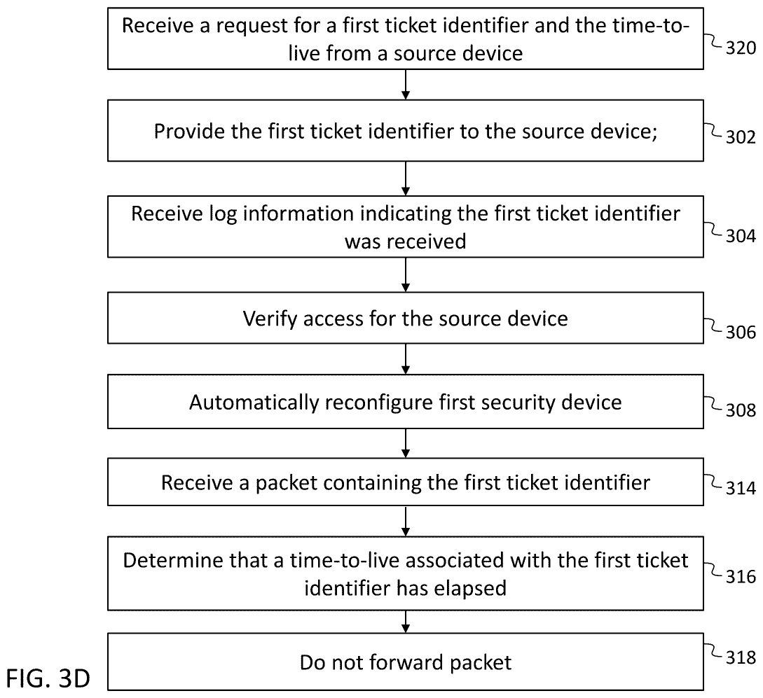

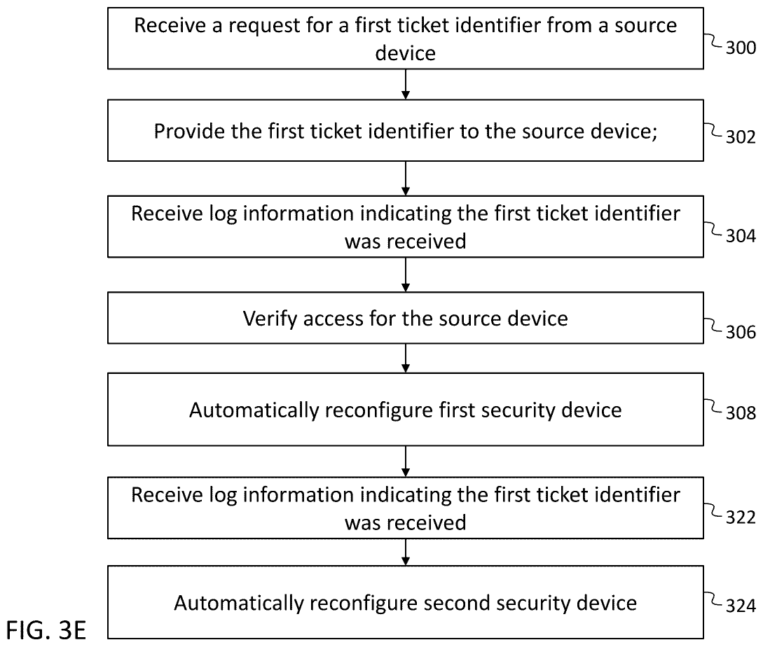

FIGS. 2A-3E are flowcharts of methods according to some examples described herein. The flowcharts, and the descriptions herein, are not intended to illustrate and describe a required order for performing the steps of the methods, and in some examples some of the steps are performed in an order differing from the order illustrated and described. Referring to FIG. 2A, in some examples, a packet, including a ticket identifier, is received, at 202; a disposition of the packet is determined, at 204, and the disposition of the packet is logged, at 206. The logging may include logging, along with the disposition of the packet, the ticket identifier and an identifier of the security device. Referring to FIG. 2B, in some examples, the method further includes determining, at 208, based on information received from an access authority, that forwarding of packets including a source IP address equal to a source IP address of the packet, and a destination IP address equal to a destination IP address of the packet is authorized; and, at 210, configuring the security device to forward packets including a source IP address equal to the source IP address of the packet, and a destination IP address equal to the destination IP address of the packet.

Referring to FIG. 2C, in some examples, the packet comprises a header and a payload, and the method further includes forwarding the packet, at 212, after removing a portion of the payload. Referring to FIG. 2D, in some examples, the determining (at 204, in FIG. 2A), of the disposition of the packet comprises determining, at 214, whether a time-to-live associated with the ticket identifier has expired. Referring to FIG. 2E, in some examples, the determining (at 204, in FIG. 2A), of the disposition of the packet comprises determining, at 216, whether the security device has received another packet including the same ticket identifier.

FIG. 3A is a flowchart of a method according to some examples described herein. In some examples, a request for a first ticket identifier is received, at 300, from a source device; the first ticket identifier is provided, at 302, to the source device; log information is received, at 304, from a first security device, the log information indicating the first ticket identifier was received by the first security device; access for the source device is verified, at 306, and the first security device is automatically reconfigured, at 308, to permit packets from the source device to be passed through the first security device. Referring to FIG. 3B, in some examples, the method further includes receiving, at 310, from the first security device, a log message indicating that a packet containing a second ticket identifier was forwarded; and reporting, at 312, that the packet was forwarded by a plurality of security devices including the first security device. Referring to FIG. 3C, in some examples, the method further includes receiving, at 314, a packet containing the first ticket identifier; determining, at 316, that a time-to-live associated with the first ticket identifier has elapsed; and, at 318, not forwarding the packet.

Referring to FIG. 3D, in some examples, the method further includes receiving, at 320, the time-to-live (e.g., along with the request for the first ticket identifier) from the source device. Referring to FIG. 3E, in some examples, the method further includes receiving, at 322, log information from a second security device indicating the first ticket identifier was received by the second security device; and automatically reconfiguring, at 324, the second security device, to permit packets from the source device to be passed through the second security device.

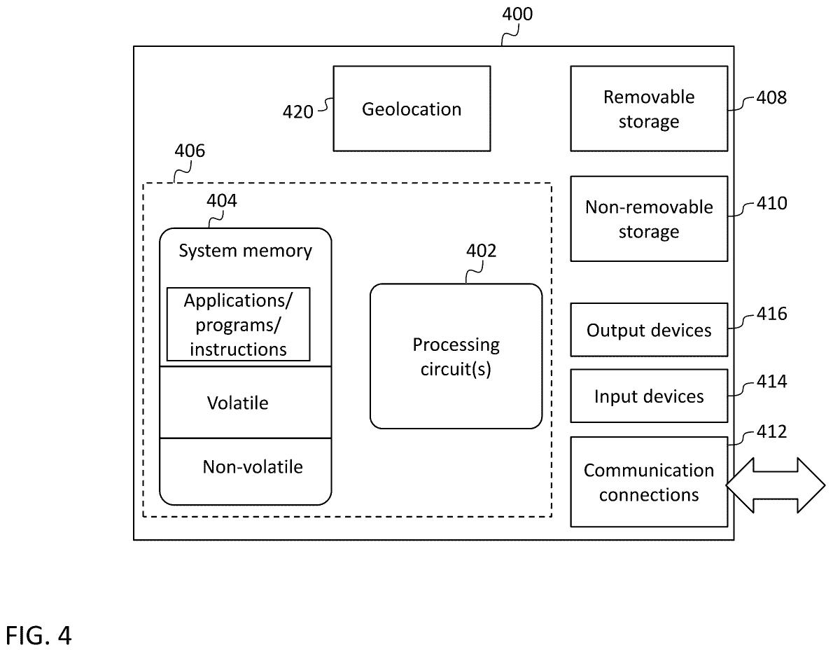

FIG. 4 depicts an example of a suitable operating environment 400, portions of which may be used to implement a security device 105 or a user computing device, or other computing devices within the systems discussed herein. In its most basic configuration, operating environment 400 typically includes at least one processing circuit 402 and memory 404. The processing circuit may be a processor, which is hardware. Depending on the exact configuration and type of computing device, memory 404 (storing instructions to perform the methods disclosed herein) may be volatile (such as RAM), non-volatile (such as ROM, flash memory, etc.), or some combination of the two. This most basic configuration is illustrated in FIG. 4 by dashed line 406. The memory 404 stores instructions that, when executed by the processing circuit(s) 402, perform the processes and operations described herein. Further, environment 400 may also include storage (removable 408, or non-removable 410) including, but not limited to, solid-state, magnetic disks, optical disks, or tape. Similarly, environment 400 may also have input device(s) 414 such as keyboard, mouse, pen, voice input, etc., or output device(s) 416 such as a display, speakers, printer, etc. Additional communication connections 412 may also be included that allow for further communication with LAN, WAN, point-to-point, etc. Operating environment 400 may also include geolocation devices 420, such as a global positioning system (GPS) device.

Operating environment 400 typically includes at least some form of computer readable media. Computer readable media can be any available media that can be accessed by processing circuit 402 or other devices comprising the operating environment. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transitory medium which can be used to store the desired information. Computer storage media is non-transitory and tangible and does not include communication media.

Communication media embodies computer readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, microwave, and other wireless media. Combinations of any of the above should also be included within the scope of computer readable media.

As used herein, the word “or” is inclusive, so that, for example, “A or B” means any one of (i) A, (ii) B, and (iii) A and B. As used herein, when a method or a first quantity (e.g., a first variable) is referred to as being “based on” a second quantity (e.g., a second variable) it means that the second quantity is an input to the method or influences the first quantity, e.g., the second quantity may be an input (e.g., the only input, or one of several inputs) to a function that calculates the first quantity, or the first quantity may be equal to the second quantity, or the first quantity may be the same as (e.g., stored at the same location or locations in memory as) the second quantity.

The term “processing circuit” is used herein to mean any combination of hardware, firmware, and software, employed to process data or digital signals. Processing circuit hardware may include, for example, application specific integrated circuits (ASICs), general purpose or special purpose central processing units (CPUs), digital signal processors (DSPs), graphics processing units (GPUs), and programmable logic devices such as field programmable gate arrays (FPGAs). In a processing circuit, as used herein, each function is performed either by hardware configured, i.e., hard-wired, to perform that function, or by more general-purpose hardware, such as a CPU, configured to execute instructions stored in a non-transitory storage medium. A processing circuit may be fabricated on a single printed circuit board (PCB) or distributed over several interconnected PCBs. A processing circuit may contain other processing circuits; for example, a processing circuit may include two processing circuits, an FPGA and a CPU, interconnected on a PCB.

Furthermore, examples of the invention may be practiced in an electrical circuit comprising discrete electronic elements, packaged or integrated electronic chips containing logic gates, a circuit utilizing a microprocessor, or on a single chip containing electronic elements or microprocessors. For example, examples of the invention may be practiced via a system-on-a-chip (SOC) where each or many of the components illustrated in FIG. 4 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to generating suggested queries, may be operated via application-specific logic integrated with other components of the operating environment 400 on the single integrated circuit (chip). Examples of the present disclosure may also be practiced using other technologies capable of performing logical operations such as, for example, AND, OR, and NOT, including but not limited to mechanical, optical, fluidic, and quantum technologies.

Although exemplary embodiments of a system and method for managing network access have been specifically described and illustrated herein, many modifications and variations will be apparent to those skilled in the art. Accordingly, it is to be understood that a system and method for managing network access constructed according to principles of this disclosure may be embodied other than as specifically described herein. The invention is also defined in the following claims, and equivalents thereof.

What is claimed is:

1. A method, comprising:
receiving, by a security device, a packet including a ticket identifier;
determining, by the security device, a disposition of the packet; and
logging, by the security device, the disposition of the packet, with:
the ticket identifier, and
an identifier of the security device.

2. The method of claim 1, wherein the ticket identifier comprises a password.

3. The method of claim 1, wherein the ticket identifier comprises a user-supplied number.

4. The method of claim 1, wherein the ticket identifier comprises a source IP address.

5. The method of claim 1, wherein the ticket identifier comprises a digital signature.

6. The method of claim 1, further comprising:
determining, based on information received from an access authority, that forwarding of packets including a source IP address equal to a source IP address of the packet, and a destination IP address equal to a destination IP address of the packet is authorized; and
configuring the security device to forward packets including a source IP address equal to the source IP address of the packet, and a destination IP address equal to the destination IP address of the packet.

7. The method of claim 1, wherein:
the packet comprises a header and a payload, and
the method further comprises forwarding the packet after removing a portion of the payload.

8. The method of claim 1, wherein the determining, by the security device, of the disposition of the packet comprises determining whether a time-to-live associated with the ticket identifier has expired.

9. The method of claim 1, wherein the determining, by the security device, of the disposition of the packet, comprises determining whether the security device has received another packet including the same ticket identifier.

10. The method of claim 1, wherein an Internet Protocol (IP) Options field of a header of the packet includes the ticket identifier.

11. A method, comprising:
receiving a request for a first ticket identifier from a source device;
providing the first ticket identifier to the source device;
receiving log information from a first security device indicating the first ticket identifier was received by the first security device;
verifying access for the source device; and
automatically reconfiguring the first security device to permit packets from the source device to be passed through the first security device.

12. The method of claim 11, further comprising:
receiving, from the first security device, a log message indicating that a packet containing a second ticket identifier was forwarded; and
reporting that the packet was forwarded by a plurality of security devices including the first security device.

13. The method of claim 11, further comprising:
receiving a packet containing the first ticket identifier;
determining that a time-to-live associated with the first ticket identifier has elapsed; and
not forwarding the packet.

14. The method of claim 13, further comprising receiving the time-to-live from the source device.

15. The method of claim 11, further comprising:
receiving log information from a second security device indicating the first ticket identifier was received by the second security device; and
automatically reconfiguring the second security device to permit packets from the source device to be passed through the second security device.

16. A security device, comprising:
at least one processing circuit;
memory, operatively connected to the at least one processing circuit and storing instructions that, when executed by the at least one processing circuit, causes the security device to perform a method, the method comprising:
receiving a packet including a ticket identifier;
determining a disposition of the packet; and
logging the disposition of the packet, with:
the ticket identifier, and
an identifier of the security device.

17. The security device of claim 16, wherein:
the packet comprises a header and a payload, and
the method further comprises forwarding the packet after removing a portion of the payload.

18. The security device of claim 16, wherein the determining of the disposition of the packet comprises determining whether a time-to-live associated with the ticket identifier has expired.

19. The security device of claim 16, wherein the determining of the disposition of the packet comprises determining whether the security device has received another packet including the same ticket identifier.

20. The security device of claim 16, wherein an Internet Protocol (IP) Options field of a header of the packet includes the ticket identifier.
